(19) United States
(12) Patent Application Publication
(10) Pub. No.: US 2026/0088580 A1
(43) Pub. Date: Mar. 26, 2026

(54) BUSBAR CONNECTOR

(71) Applicant: JPC connectivity Inc., New Taipei City (TW)

(72) Inventors: Hsu-Feng CHANG, New Taipei City (TW); Zhen-Xiong SHUAI, New Taipei City (TW)

(21) Appl. No.: 18/936,979

(22) Filed: Nov. 4, 2024

(30) Foreign Application Priority Data
Sep. 24, 2024 (CN) 202422333786.0

(51) Int. Cl. H01R 25/16

(52) U.S. Cl. CPC H01R 25/162

(57) ABSTRACT

A busbar connector having an insulating body and a pre-assembled component is provided. The insulating body defines a through slot and an inner surface. The pre-assembled component plugs in the through slot along a first direction and includes an insulating core, two power clamping terminals, and two signal terminals. The insulating core defines two embedding grooves and two fastening grooves. The power clamping terminals respectively plug in the embedding grooves in parallel and along a second direction perpendicular to the first direction. The signal terminals are respectively arranged in each of the fastening grooves and parallel to the first direction. The insulating core and the inner surface together cover a portion of an outer edge of the power clamping terminals and a portion of an outer edge of the signal terminals. The power clamping terminals may be prevented from detaching when the busbar connector is pulled out.

### BACKGROUND

### Technical Field

The present disclosure relates to connector field, particularly to a busbar connector.

### Description of Related Art

The busbar connector is mainly used in electronic device such as server or power storage cabinet to achieve the effect of power transmission. Existing busbar connector mainly plugs a pair of power terminals electrically connected with a plurality of power cables into an insulating housing and form an electrical connection to transmit power by clamping a conductor board of the server or the power storage cabinet with two oppositely configured power terminals. However, since the power terminals require a strong clamping force to prevent from detaching from the conductor board during use, the busbar connector may cause the power terminals to be tugged and be detached relative to the insulating housing when the busbar connector is pulled out, this results structural damage and causes the power terminals to be unusable.

In addition, in existing busbar connector, two sides of an end of the power terminals usually connect the power cables by high-frequency soldering or crimping. However, since high-frequency soldering may only be performed on one side at a time, the power cables that have been soldered to one side of the power terminals will fall off when the power cables are soldering to the other side of the power terminals. Besides, the power terminals to which the power cables are soldered on both sides are of a large size and take up a lot of space inside the busbar connector, resulting in short creepage distance and insulation failure.

In view of the above, the inventor seeks to overcome the aforementioned drawbacks associated with the current technology and aims to provide an effective solution through extensive researches along with utilization of academic principles and knowledge.

### SUMMARY

The primary objective of the present disclosure is to limit and fix the power clamping terminals and the signal terminals, so as to effectively enhance insulation performance and prevent the power clamping terminals and the signal terminals from detaching when the busbar connector is pulled out.

To accomplish the aforementioned objective, the present disclosure provides a busbar connector having an insulating body and a pre-assembled component. The insulating body defines a through slot and an inner surface. The inner surface surrounds a periphery of the through slot. The pre-assembled component plugs in the through slot along a first direction. The pre-assembled component includes an insulating core, a pair of power clamping terminals, and a pair of signal terminals. The insulating core defines a pair of embedding grooves and a pair of fastening grooves. Each of the power clamping terminals plugs in each of the embedding grooves along a second direction and arranged in parallel such that the insulating core and the inner surface together cover a portion of an outer edge of each of the power clamping terminals. The first direction is perpendicular to the second direction. Each of the signal terminals is arranged in each of the fastening grooves and parallel to the first direction such that the insulating core and the inner surface together cover a portion of an outer edge of each of the signal terminals.

Another aspect of the present disclosure provides that the insulating core has a plurality of fastening hooks, the insulating body has a plurality of reverse hooks, each of the reverse hooks is arranged on the inner surface and buckled to each of the fastening hooks such that the insulating body blocks the insulating core along the first direction.

Another aspect of the present disclosure provides that in each of the power clamping terminals, the power clamping terminal has a stopping arm, the sopping arm is extended along the second direction and blocks an outer side of the insulating core such that the insulating core blocks the power clamping terminal along the first direction.

Another aspect of the present disclosure provides that each of the signal terminals has a pair of positioning sheets, each of the positioning sheets is arranged at intervals along the first direction, the insulating core defines two pair of limiting grooves respectively corresponding to each of the fastening grooves, each of the limiting grooves of each pair of the limiting grooves is arranged at intervals along the first direction and communicated to the corresponding fastening groove, each of the positioning sheets of each of the signal terminals is fixed in each of the limiting grooves such that the insulating core simultaneously limits each of the signal terminals along the first direction and a reverse direction of the first direction.

Another aspect of the present disclosure provides that the pre-assembled component further includes a pair of shield terminals, the insulating body has a pair of clamping plates, each of the clamping plates is extended along the first direction and arranged in parallel, each of the shield terminals is arranged on an outer side of each of the clamping plates, each of the power clamping terminals is arranged on an inner side of each of the clamping plates and located between each of the shield terminals.

Another aspect of the present disclosure provides that each of the shield terminals has a pressing portion parallel to the first direction and an inserting portion parallel to the first direction, each of the pressing portions is attached on two opposite sides of the insulating body, each of the inserting portions plugs in the insulating body along a reverse direction of the first direction, each of the pressing portions defines a first buckle hole, each of the inserting portions defines a second buckle hole, the insulating body has a pair of first buckles, each of the first buckles is arranged correspondingly to each of the clamping plates and buckles each of the first buckle holes, the insulating core has a pair of second buckles, each of the second buckles is arranged on two opposite sides of the insulating core and buckles each of the second buckle holes.

Another aspect of the present disclosure provides that the pair of the embedding grooves and the pair of fastening grooves are respectively located on two opposite sides of the insulating core.

Another aspect of the present disclosure provides that in each of the power clamping terminals, the power clamping terminal includes a folding plate, a joint plate, and a plurality of elastic clamping arms, the folding plate includes a first plate, a second plate, and a connecting rib, the connecting rib bendingly connects the first plate and the second plate such that the first plate is attached to the second plate, each of the elastic clamping arms is extended along the first direction from the folding plate, the joint plate is attached to the second plate and coplanar with the first plate.

Another aspect of the present disclosure provides that the pre-assembled component further includes a plurality of first power cables, a plurality of second power cables, and a pair of signal cables, each of the first power cables is welded to the second plate and the joint plate of one of the power clamping terminals, each of the second power cables is welded to the second plate and the joint plate of the other power clamping terminal, each of the signal cables is electrically connected to each of the signal terminals.

Another aspect of the present disclosure provides that in each of the power clamping terminals, the joint plate is fixed to the second plate by riveting, welding, screwing, or bonding.

In the present disclosure, the power clamping terminals respectively plug in the embedding grooves along the second direction, and the signal terminals are respectively arranged in each of the fastening grooves, the insulating core and the inner surface together cover the portion of the outer edge of the power clamping terminals and the portion of the outer edge of the signal terminals. Therefore, the busbar connector of the present disclosure may limit and fix the power clamping terminals and the signal terminals, so as to effectively enhance insulation performance and prevent the power clamping terminals and the signal terminals from detaching when the busbar connector is pulled out.

### BRIEF DESCRIPTION OF THE DRAWINGS

FIG. 1 is a perspective appearance view of the present disclosure;

FIG. 2 is an exploded view of the insulating body and the pre-assembled component of the present disclosure;

FIG. 3 is a partial exploded view of the present disclosure;

FIG. 4 is another partial exploded view of the present disclosure;

FIG. 5 is a cross-sectional side view of the present disclosure;

FIG. 6 is a cross-sectional top view of the present disclosure;

FIG. 7 is an exploded view of the present disclosure; and

FIG. 8 is another cross-sectional side view of the present disclosure.

### DETAILED DESCRIPTION

It is to be understood that the terms for indicating positions and the location relation, for example “front”, “rear”, “left”, “right”, “front end”, “rear end”, “distal end”, “longitudinal direction”, “lateral direction”, “vertical direction”, “top” and “bottom”, are based on the positions and the location relation disclosed in the drawings, and only used for disclosing the present disclosure and not used for indicating or implying the specified location of the device or the components or the specified structure and operation in certain location, thus the present disclosure is not intended to be limiting.

For example, the terms of “first”, “second”, “third”, “forth” and “fifth” are used for illustrating each unit, component, area, layer and/or part. The component, the unit, the area, the layer and/or the part are not limited by the terms. These terms are only used for separating the element, the assembly, the area, the layer, or the part. Unless being clearly indicated according to the whole specification, the terms for example “the first”, “the second”, “the third”, “the fourth” and “the fifth” are not used for implying the order or sequence.

As used herein and not otherwise defined, the terms “substantially” and “approximately” are used to describe and describe small changes. When used in connection with an event or situation, the terms may include the precise moment at which the event or situation occurs, as well as the event or situation occurring to a close approximation. For example, when combined with a numerical value, the terms may include a range of variation equal to or less than ±5% of the numerical value, such as equal to or less than ±4%, equal to or less than ±3%, equal to or less than ±2%, equal to or less than ±1%, equal to or less than ±0.5%, equal to or less than ±0.1%, or equal to or less than ±0.05%.

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

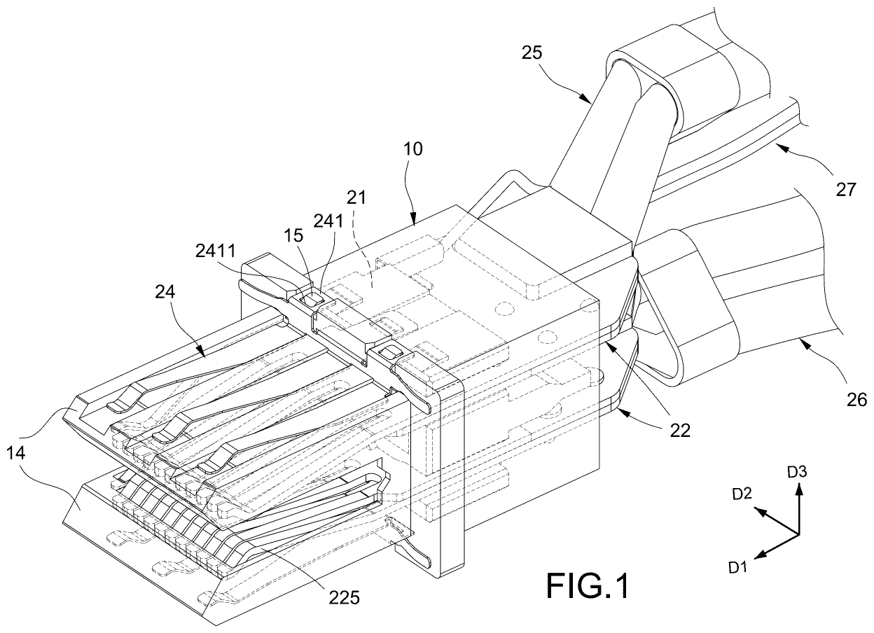

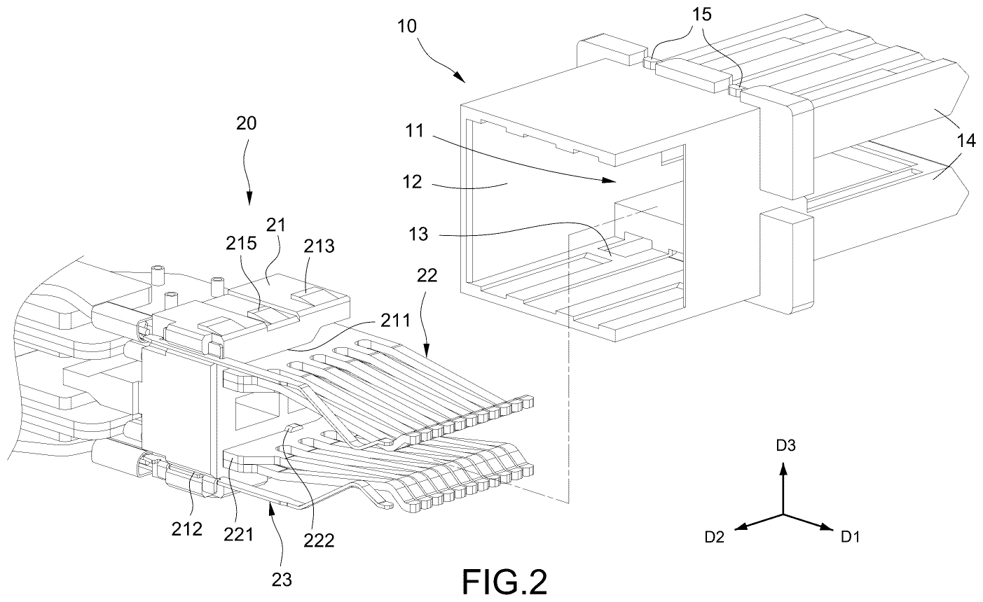

The present disclosure provides a busbar connector. Please refer to FIG. 1 and FIG. 2, the busbar connector of the present disclosure includes an insulating body 10 and a pre-assembled component 20.

In the embodiment, the insulating body 10 is in one piece by plastic injection molding, but the present disclosure is not limited to this embodiment. The insulating body 10 may also made of other insulating material. The insulating body 10 defines a through slot 11 and an inner surface 12. The through slot 11 passes through the insulating body 10 along a first direction D1. In the embodiment, the through slot 11 is a rectangular slot passing through the insulating body 10, the first direction D1 is a front-rear direction of the insulating body 10 and an insulating core 21 described later in figures, but the present disclosure is not limited to this embodiment. The inner surface 12 surrounds a periphery of the through slot 11. In detail, the inner surface 12 in the embodiment is formed by four planes.

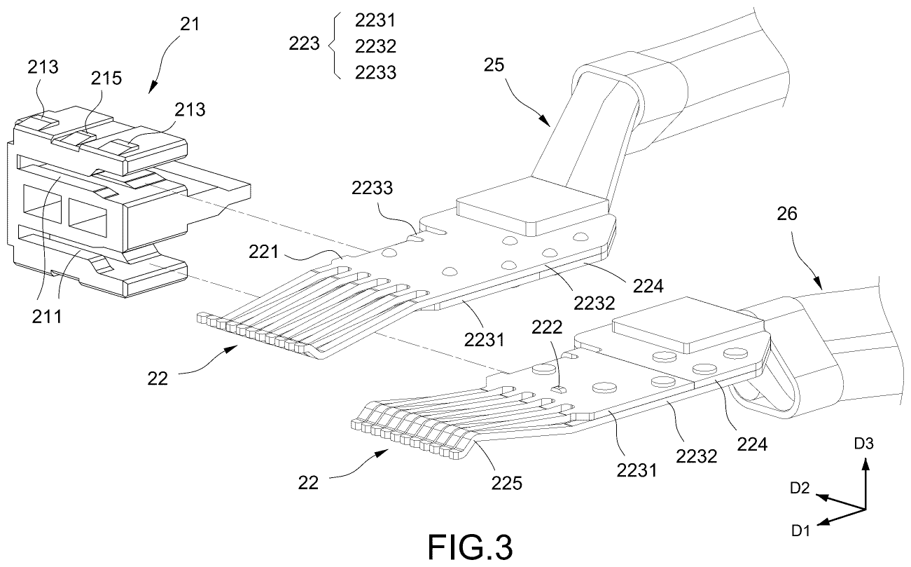

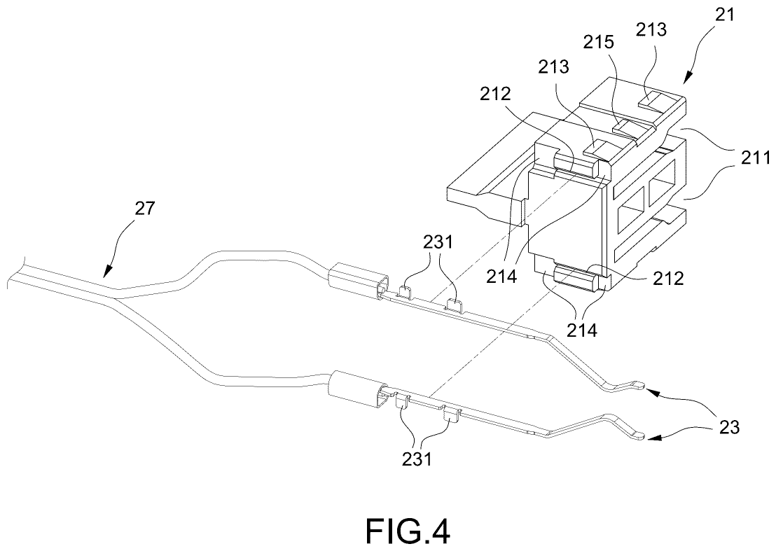

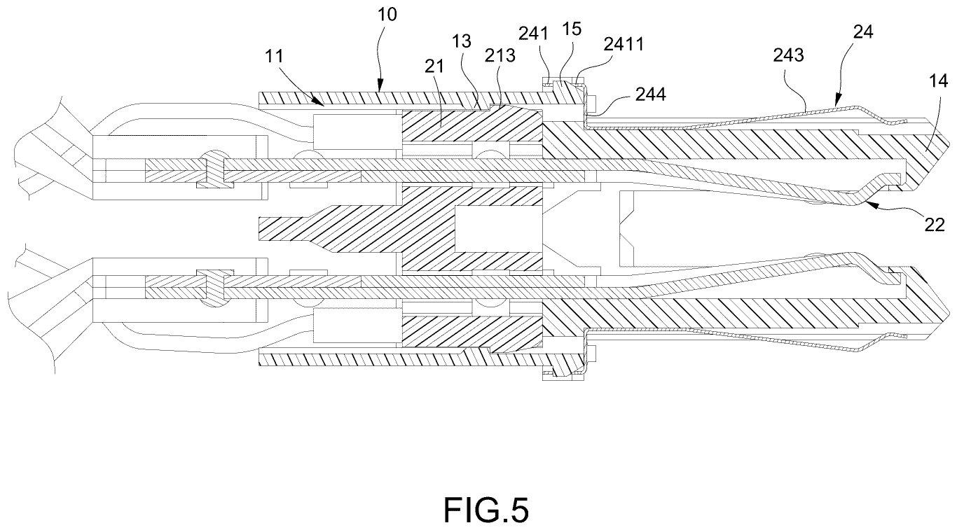

The pre-assembled component 20 plugs in the through slot 11 of the insulating body 10 along the first direction D1 to be fixed in the insulating body 10. Please refer to FIG. 2, FIG. 3, FIG. 4, and FIG. 5. The pre-assembled component 20 mainly includes the insulating core 21, a pair of power clamping terminals 22, and a pair of signal terminals 23. The insulating core 21 is a rectangular block and defines a pair of embedding grooves 211 and a pair of fastening grooves 212. In the embodiment, the pair of embedding grooves 211 and the pair of fastening grooves 212 are respectively located on two opposite sides (left side and right side) of the insulating core 21, but the present disclosure is not limited to this embodiment. For example, the pair of embedding grooves 211 and the pair of fastening grooves 212 may also be respectively located on same side or other different sides of the insulating core 21. Each of the power clamping terminals 22 plugs in each of the embedding grooves 211 along a second direction D2, and each of the power clamping terminals 22 is arranged along a third direction D3 in parallel. Therefore, the insulating core 21 and the inner surface 12 together cover at least one portion of an outer edge of each of the power clamping terminals 22 to limit and fix each of the power clamping terminals 22. In the embodiment, the second direction D2 is a left-right direction of the insulating body 10 and the insulating core 21 in figures, and the third direction D3 is an up-down direction of the insulating body 10 and the insulating core 21 in figures. Therefore, the first direction D1, the second direction D2, and the third direction D3 are all perpendicular to each other. Each of the signal terminals 23 is arranged in each of the fastening grooves 212, and each of the signal terminals 23 is parallel to the first direction D1. Therefore, the insulating core 21 and the inner surface 12 together cover at least one portion of an outer edge of each of the signal terminals 23 to limit and fix each of the signal terminals 23.

Therefore, the assembler may previously plug each of the power clamping terminals 22 in each of the embedding grooves 211 along the second direction D2 and put each of the signal terminals 23 to be arranged in each of the fastening grooves 212 to assemble the pre-assembled component 20, so as to preliminarily fix each of the power clamping terminals 22 and each of the signal terminals 23. The assembler then plugs the pre-assembled component 20 in the through slot 11 along the first direction D1 to fix the pre-assembled component 20 in the insulating body 10 such that the insulating core 21 and the inner surface 12 together cover the portion of the outer edge of each of the power clamping terminals 22 and the portion of the outer edge of each of the signal terminals 23. Therefore, the busbar connector of the present disclosure may limit and fix each of the power clamping terminals 22 and each of the signal terminals 23, so as to effectively enhance insulation performance and prevent each of the power clamping terminals 22 and each of the signal terminals 23 from detaching when the busbar connector is pulled out.

Details are provided as follows. The insulating core 21 has a plurality of fastening hooks 213. The insulating body 10 has a plurality of reverse hooks 13. Each of the reverse hooks 13 is arranged on the inner surface 12 of the insulating body 10, and each of the reverse hooks 13 buckles to each of the fastening hooks 213 such that the insulating body 10 blocks the insulating core 21 along the first direction D1 to prevent the insulating core 21 from detaching from the insulating body 10. In detail, the fastening hooks 213 are respectively arranged on a top and a bottom of the insulating core 21, and the reverse hooks 13 are respectively arranged on a top and a bottom of the inner surface 12, so as to not interfere with the power clamping terminals 22 and the signal terminals 23 arranged on the left side and the right side of the insulating core 21. In the embodiment, both a number of the fastening hook 213 and a number of the reverse hook 13 are four, two of the fastening hooks 213 are arranged on the top of the insulating core 21 in intervals along the second direction D2, the other two fastening hooks 213 are arranged on the bottom of the insulating core 21 in intervals along the second direction D2, two of the reverse hooks 13 are arranged on the top of the inner surface 12 in intervals along the second direction D2, the other two reverse hooks 13 are arranged on the bottom of the inner surface 12 in intervals along the second direction D2, but the number of the fastening hook 213 and the number of the reverse hook 13 of the present disclosure is not limited to this embodiment.

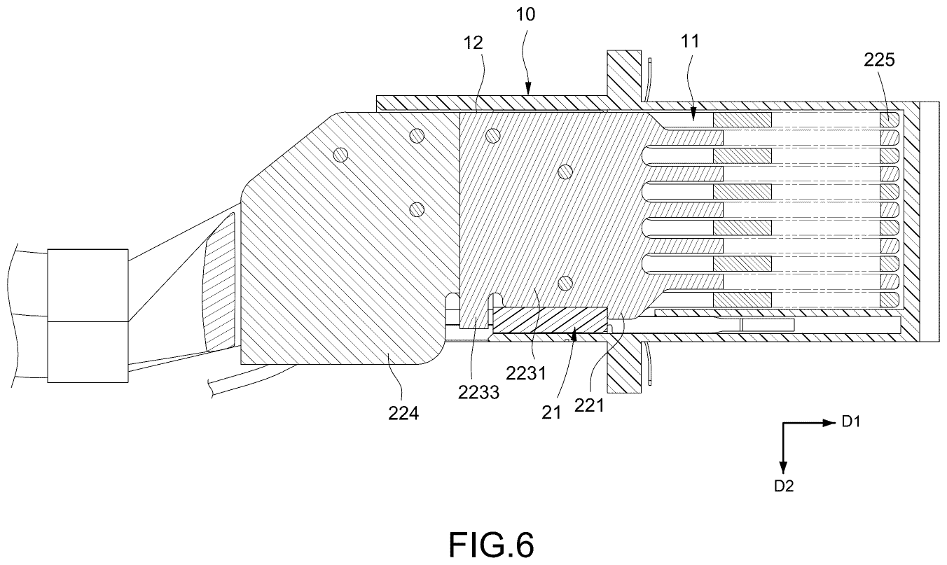

Please refer to FIG. 2, FIG. 3, and FIG. 6. Each of the power clamping terminals 22 has a stopping arm 221. In each of the power clamping terminals 22, the sopping arm 221 is extended along the second direction D2 and blocks an outer side of the insulating core 21 such that the insulating core 21 blocks the power clamping terminal 22 along the first direction D1. Therefore, the busbar connector may prevent the power clamping terminals 22 from detaching along a reverse direction of the first direction D1 when the busbar connector is pulled out. In addition, each of the power clamping terminals 22 in the embodiment further has a stopping block 222 extended along the third direction D3 or a reverse direction of the third direction D3. Each of the stopping blocks 222 of each of the power clamping terminals 22 also blocks the outer side of the insulating core 21, and the stopping block 222 and the stopping arm 221 in each of the power clamping terminals 22 are located on different sides. Therefore, the stopping blocks 222 not only may further improve the stopping effect, but also may prevent each of the power clamping terminals 22 from rotating with each of the stopping arms 221 as a fulcrum.

Please refer to FIG. 2 and FIG. 4 again. Each of the signal terminals 23 has a pair of positioning sheets 231. Each of the positioning sheets 231 of each of the signal terminals 23 is arranged at intervals along the first direction D1 and extended along the third direction D3 or the reverse direction of the third direction D3. The insulating core 21 defines two pair of limiting grooves respectively corresponding to each of the fastening grooves 212. In detail, each of the limiting grooves 214 of each pair of the limiting grooves 214 is arranged at intervals along the first direction D1 and communicated to the corresponding fastening groove 212. Each of the positioning sheets 231 of each of the signal terminals 23 is fixed in each of the limiting grooves 214. Therefore, the insulating core 21 simultaneously limits each of the signal terminals 23 along the first direction D1 and the reverse direction of the first direction D1 to prevent each of the signal terminals 23 from detaching from the insulating core 21.

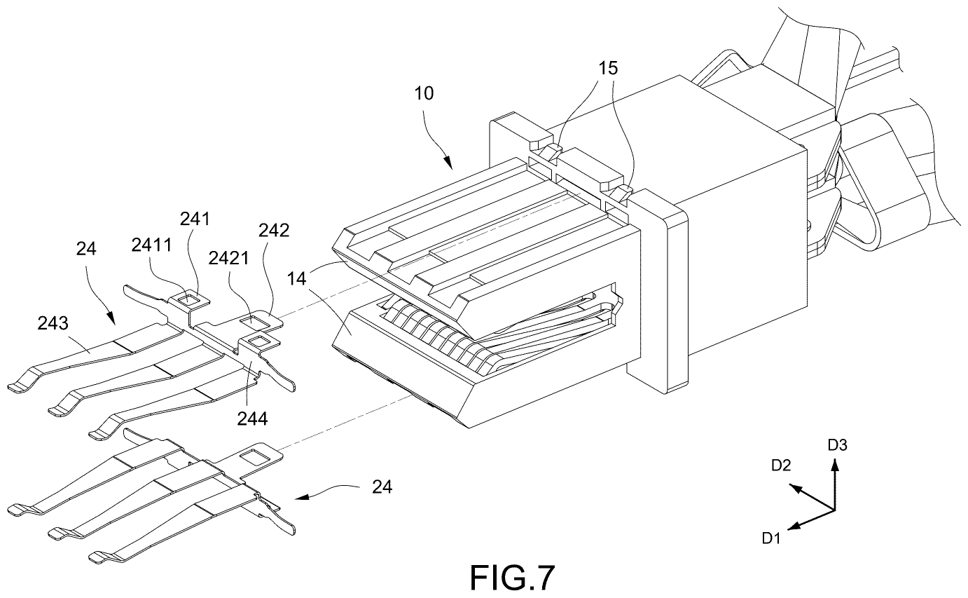

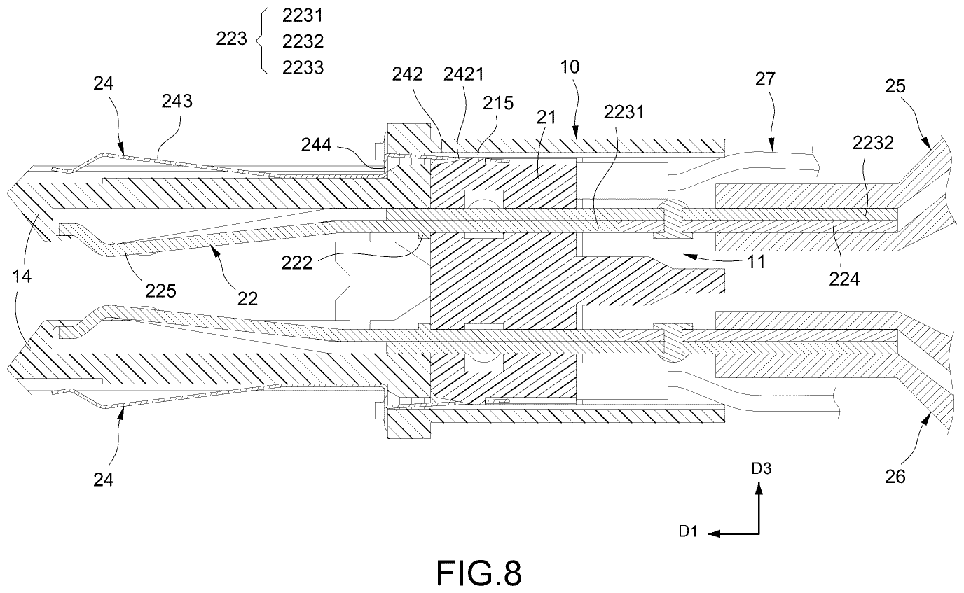

Please refer to FIG. 1, FIG. 2, FIG. 7, and FIG. 8. The pre-assembled component 20 further includes a pair of shield terminals 24. The insulating body 10 has a pair of clamping plates 14 located on a front end thereof. Each of the clamping plates 14 is extended along the first direction D1 and arranged in parallel along the third direction D3. Each of the shield terminals 24 is arranged on an outer side of each of the clamping plates 14 (that is a top portion and a bottom portion of the front end of the insulating body 10), and each of the power clamping terminals 22 is arranged on an inner side of each of the clamping plates 14 and located between each of the shield terminals 24.

Each of the shield terminals 24 has a pressing portion 241 parallel to the first direction D1 and an inserting portion 242 parallel to the first direction D1. In each of the shield terminals 24 in the embodiment, the pressing portion 241 is not coplanar with the inserting portion 242, but the pressing portion 241 may be coplanar with the inserting portion 242 in each of the shield terminals 24 in another embodiment. Each of the pressing portions 241 is attached on two opposite sides (top side and bottom side) of the insulating body 10. Each of the inserting portions 242 plugs in the insulating body 10 along the reverse direction of the first direction D1. Therefore, each of the shield terminals 24 is preliminary fixed to the insulating body 10. In addition, each of the pressing portions 241 defines a first buckle hole 2411, and each of the inserting portions 242 defines a second buckle hole 2421. The insulating body has at least one pair of first buckles 15. Each of the first buckles 15 is arranged on two opposite sides (top side and bottom side) of the insulating core 21 and corresponding to each of the clamping plates 14, and each of the first buckles 15 buckles each of the first buckle holes 2411. The insulating core 21 has a pair of second buckles 215. Each of the second buckles 215 is arranged on two opposite sides (top side and bottom side) of the insulating core 21, and each of the second buckles 215 buckles each of the second buckle holes 2421. Each of the first buckles 15 of the insulating body 10 and each of the second buckles 215 of the insulating core 21 respectively buckles each of the first buckle holes 2411 and each of the second buckle holes 2421 of the shield terminals 24, thus the shield terminals 24 may further be fixed to the insulating body 10 to prevent the shield terminals 24 from detaching from the insulating body 10. In the embodiment, a number of the pressing portions 241 of each of the shield terminals 24 is two and the pressing portions 241 are arranged in intervals along the second direction D2, and a number of the first buckle 15 is two pairs and arranged in intervals along the second direction D2, so as to greatly improve the buckling effect through the four first buckles 15 buckling the four first buckle holes 2411, but the present disclosure is not limited to this embodiment.

Details are provided as follows. Each of the shield terminals 24 further has a plurality of shield arms 243 and an abutting sheet 244. In each of the shield terminals 24, the abutting sheet 244 is attached to the insulating body 10, the pressing portion 241 and the inserting portion 242 are extended along the reverse direction of the first direction D1 from the abutting sheet 244, and the shield arms 243 are extended along the first direction D1 from the abutting sheet 244. More particularly, the abutting sheet 244 in each of the shield terminals 24 is substantially perpendicularly connected to the shield arms 243, the pressing portion 241, and the inserting portion 242.

Please refer to FIG. 1, FIG. 2, FIG. 3, FIG. 5, FIG. 6, FIG. 7, and FIG. 8 again. Each of the power clamping terminal 22 includes a folding plate 223, a joint plate 224, and a plurality of elastic clamping arms 225. Each of the folding plate 223 includes a first plate 2231, a second plate 2232, and a connecting rib 2233. In each of the folding plate 223, the connecting rib 2233 is U-shaped and bendingly connects the first plate 2231 and the second plate 2232 such that the first plate 2231 is attached to the second plate 2232. In each of the power clamping terminal 22, each of the elastic clamping arms 225 is extended roughly along the first direction D1 from the folding plate 223. In detail, part of the elastic clamping arms 225 are extended from a front end of the first plate 2231, other part of the elastic clamping arms 225 are extended from a front end of the second plate 2232, such that the elastic clamping arms 225 of the first plate 2231 and the second plate 2232 are arranged in a row staggered with each other. The joint plate 224 is stacked and attached to the second plate 2232, and the joint plate 224 is coplanar with the first plate 2231. In detail, the first plate 2231 and the joint plate 224 are close or adjacent to each other, and a shape formed by the first plate 2231 and the joint plate 224 is corresponding to a shape of the second plate 2232.

In addition, the pre-assembled component 20 further includes a plurality of first power cables 25, a plurality of second power cables 26, and a pair of signal cables 27. Each of the first power cables 25 is welded to the second plate 2232 and the joint plate 224 of one of the power clamping terminals 22. In detail, in the power clamping terminal 22 welded with the first power cables 25, some of the first power cables 25 are welded to a side of the second plate 2232 away from the joint plate 224 and located on a side away the elastic clamping arms 225, other first power cables 25 are welded to the joint plate 224, that is the first power cables 25 are respectively welded to an end of a top side and a bottom side of the power clamping terminals 22. Each of the second power cables 26 is welded to the second plate 2232 and the joint plate 224 of the other power clamping terminal 22. In detail, in the power clamping terminal 22 welded with the second power cables 26, some of the second power cables 26 are welded to a side of the second plate 2232 away from the joint plate 224 and located on a side away from the elastic clamping arms 225, other second power cables 26 are welded to the joint plate 224, that is the second power cables 26 are respectively welded to an end of a top side and a bottom side of the power clamping terminals 22. Each of the signal cables 27 is electrically connected to an end of each of the signal terminals 23. In each of the power clamping terminals 22, the joint plate 24 is fixed to the second plate 2232 by riveting, welding, screwing, or bonding. In the embodiment, the joint plate 24 is fixed to the second plate 2232 by riveting, but the present disclosure is not limited to this embodiment.

Therefore, since a structure of each of the power clamping terminals 22 connected to the first power cables 25 and the second power cables 26 is divided to the second plate 2232 and the joint plate 24, the second plate 2232 and the joint plate 24 may respectively perform high-frequency soldering to make a welding space evenly distributed and optimize a creepage distance. In addition, the second plate 2232 and the joint plate 24 are fixed by riveting, welding, screwing, or bonding to form a stacked structure after the second plate 2232 and the joint plate 24 are processed with high-frequency soldering, such that the first power cables 25 and the second power cables 26 may be respectively arranged on the top side and the bottom side of the power clamping terminals 22 to ensure the strength of the overall structure and the stability of current transmission.

In the present disclosure, the power clamping terminals 22 respectively plug in the embedding grooves 211 along the second direction D2, and the signal terminals 23 are respectively arranged in each of the fastening grooves 212, the insulating core 21 and the inner surface 12 together cover the portion of the outer edge of the power clamping terminals 22 and the portion of the outer edge of the signal terminals 23. Therefore, the busbar connector of the present disclosure may limit and fix the power clamping terminals 22 and the signal terminals 23, so as to effectively enhance insulation performance and prevent the power clamping terminals 22 and the signal terminals 23 from detaching when the busbar connector is pulled out.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A busbar connector, comprising:
an insulating body, defined a through slot and an inner surface, the inner surface surrounded a periphery of the through slot; and
a pre-assembled component, plugged in the through slot along a first direction, the pre-assembled component comprising an insulating core, a pair of power clamping terminals, and a pair of signal terminals, the insulating core defining a pair of embedding grooves and a pair of fastening grooves, each of the power clamping terminals plugged in each of the embedding grooves along a second direction and arranged in parallel such that the insulating core and the inner surface together cover a portion of an outer edge of each of the power clamping terminals, the first direction perpendicular to the second direction, each of the signal terminals arranged in each of the fastening grooves and parallel to the first direction such that the insulating core and the inner surface together cover a portion of an outer edge of each of the signal terminals.

2. The busbar connector according to claim 1, wherein the insulating core comprises a plurality of fastening hooks, the insulating body comprises a plurality of reverse hooks, each of the reverse hooks is arranged on the inner surface and buckled to each of the fastening hooks such that the insulating body blocks the insulating core along the first direction.

3. The busbar connector according to claim 1, wherein in each of the power clamping terminals, the power clamping terminal comprises a stopping arm, the sopping arm is extended along the second direction and blocks an outer side of the insulating core such that the insulating core blocks the power clamping terminal along the first direction.

4. The busbar connector according to claim 1, wherein each of the signal terminals comprises a pair of positioning sheets, each of the positioning sheets is arranged at intervals along the first direction, the insulating core defines two pair of limiting grooves respectively corresponding to each of the fastening grooves, each of the limiting grooves of each pair of the limiting grooves is arranged at intervals along the first direction and communicated to the corresponding fastening groove, each of the positioning sheets of each of the signal terminals is fixed in each of the limiting grooves such that the insulating core simultaneously limits each of the signal terminals along the first direction and a reverse direction of the first direction.

5. The busbar connector according to claim 1, wherein the pre-assembled component further comprises a pair of shield terminals, the insulating body comprises a pair of clamping plates, each of the clamping plates is extended along the first direction and arranged in parallel, each of the shield terminals is arranged on an outer side of each of the clamping plates, each of the power clamping terminals is arranged on an inner side of each of the clamping plates and located between each of the shield terminals.

6. The busbar connector according to claim 5, wherein each of the shield terminals comprises a pressing portion parallel to the first direction and an inserting portion parallel to the first direction, each of the pressing portions is attached on two opposite sides of the insulating body, each of the inserting portions plugs in the insulating body along a reverse direction of the first direction, each of the pressing portions defines a first buckle hole, each of the inserting portions defines a second buckle hole, the insulating body comprises a pair of first buckles, each of the first buckles is arranged correspondingly to each of the clamping plates and buckles each of the first buckle holes, the insulating core comprises a pair of second buckles, each of the second buckles is arranged on two opposite sides of the insulating core and buckles each of the second buckle holes.

7. The busbar connector according to claim 1, wherein the pair of the embedding grooves and the pair of fastening grooves are respectively located on two opposite sides of the insulating core.

8. The busbar connector according to claim 1, wherein in each of the power clamping terminals, the power clamping terminal comprises a folding plate, a joint plate, and a plurality of elastic clamping arms, the folding plate comprises a first plate, a second plate, and a connecting rib, the connecting rib bendingly connects the first plate and the second plate such that the first plate is attached to the second plate, each of the elastic clamping arms is extended along the first direction from the folding plate, the joint plate is attached to the second plate and coplanar with the first plate.

9. The busbar connector according to claim 8, wherein the pre-assembled component further comprises a plurality of first power cables, a plurality of second power cables, and a pair of signal cables, each of the first power cables is welded to the second plate and the joint plate of one of the power clamping terminals, each of the second power cables is welded to the second plate and the joint plate of the other power clamping terminal, each of the signal cables is electrically connected to each of the signal terminals.

10. The busbar connector according to claim 8, wherein in each of the power clamping terminals, the joint plate is fixed to the second plate by riveting, welding, screwing, or bonding.
